(19) United States
(12) Patent Application Publication
(10) Pub. No.: US 2026/0343064 A1
(43) Pub. Date: Oct. 29, 2026

(54) DISPLAY DEVICE AND OPERATION METHOD THEREOF

(71) Applicant: LG ELECTRONICS INC., Seoul (KR)

(72) Inventors: Minsik KIM, Seoul (KR); Jeongjoo LEE, Seoul (KR)

(73) Assignee: LG ELECTRONICS INC., Seoul (KR)

(21) Appl. No.: 19/124,257

(22) PCT Filed: Oct. 28, 2022
(86) PCT No.: PCT/KR2022/016632

§ 371 Date: Apr. 24, 2025

(51) Int. Cl. H04N 21/485; G06F 3/0482; G06F 3/16; H04N 21/422

(52) U.S. Cl. CPC H04N 21/4852; G06F 3/0482; G06F 3/165; H04N 21/42204

(57) ABSTRACT

Disclosed are a display device and an operation method thereof. The display device according to at least one embodiment among various embodiments disclosed herein comprises: a display and a processor for controlling the display. The processor may create and output an external audio device information menu and, when a first user input to the external audio device information menu is received, may receive audio device information collected from an external audio device according to the first user input and create and output a user interface including at least one of current state information about the external audio device and control information about the external audio device, the user interface being created on the basis of the audio device information.

### TECHNICAL FIELD

The present disclosure relates to a display device and an operating method thereof.

### Background Art

Recently, the functions of terminals have been diversified, for example, data and voice communication, taking pictures and videos using a camera, recording voice, playing music files using a speaker system, and outputting images or videos to a display.

Some terminals have an added electronic game play function or perform a multimedia player function.

As the functions of such terminals have diversified, they are implemented in the form of multimedia players with complex functions such as taking pictures or videos, playing music or video files, playing games, and receiving broadcasts.

Since conventional TVs were mainly used as devices for watching broadcast programs, they were relatively less sensitive to audio output, and built-in speakers were mainly used.

However, as mentioned above, recently, display devices are recognized and operated as multimedia devices for various external inputs in addition to broadcast programs, and interest in audio output has also increased significantly, and users who want to enjoy content through high-performance external speakers are increasing.

However, these external speakers have been inconvenient to use because they do not have a display device or are equipped with a very small display in relation to their status information or control.

### DETAILED DESCRIPTION OF THE INVENTION

### Technical Problem

The present disclosure is intended to provide information on an external audio device through a display device.

The present disclosure is intended to control an external audio device through a display device.

### Technical Solution

According to at least one embodiment of the various embodiments of the present disclosure, a display device can include: a display; and a processor configured to control the display, wherein the processor is configured to configure and output an external audio device information menu, when a first user input for the external audio device information menu is received, receive audio device information collected from an external audio device according to the first user input, and configure and output a user interface including at least one of current status information of the external audio device and control information for the external audio device based on the audio device information.

According to the display device according to at least one embodiment of the various embodiments of the present disclosure, the audio device information can include at least one of information on a volume of the external audio device, connection status information of the external audio device, status information of a device for wireless connection of the external audio device, and equalizer information of the external audio device, and wherein the processor is configured to generate the current status information and the control information for each external audio device based on the audio device information.

According to a display device according to at least one embodiment of the various embodiments of the present disclosure, when the first user input is received, the processor can be configured to transmit a request signal of the audio device information to the external audio device.

According to a display device according to at least one embodiment of the various embodiments of the present disclosure, the processor can be configured to receive a second user input for control information in the user interface, generate an external audio device control command corresponding to the second user input, and transmit the external audio device control command to the external audio device.

According to a display device according to at least one embodiment of the various embodiments of the present disclosure, the external audio device can be configured to include a main audio device and an auxiliary audio device.

According to a display device according to at least one embodiment of the various embodiments of the present disclosure, the processor can be configured to transmit at least one of the request signal of the audio device information and the external audio device control command to the main audio device using an HDMI-CEC protocol.

According to a display device according to at least one embodiment of the various embodiments of the present disclosure, the processor can be configured to use vendor command information in the HDMI-CEC protocol.

According to a display device according to at least one embodiment of the various embodiments of the present disclosure, the processor can be configured to receive, from the main audio device, volume level information set according to the second user input, and output the volume level information through the display.

According to a display device according to at least one embodiment of the various embodiments of the present disclosure, the processor can be configured to output the volume level information, received from the main audio device, to the display, and wherein the processor can be configured to convert and output a volume level range and the set volume level information of the main audio device to be matched with a volume level range of the display device.

According to a display device according to at least one embodiment of the various embodiments of the present disclosure, the processor can be configured to receive, from the main audio device, connection status information between the main audio device and the auxiliary audio device requested according to the second user input, and output the connection status information through the display.

According to a display device according to at least one embodiment of the various embodiments of the present disclosure, the processor can be configured to receive dongle and wireless connection status information for wireless connection between the display device and the external audio device requested according to the second user input, and output the dongle and wireless connection status information for wireless connection between the display device and the external audio device on a main display.

According to a display device according to at least one embodiment of the various embodiments of the present disclosure, the processor can be configured to receive equalizer setting information for the external audio device requested according to the second user input, and output the equalizer setting information through the display on a main display.

According to a display device according to at least one embodiment of the various embodiments of the present disclosure, the processor can be configured to pre-store information on a status of a preferred external audio device based on at least one of visual information and spatial information to which the display device belongs on the basis of a user logged into the display device, when providing the user interface, obtain information on at least one of the current visual information, the user currently logged into the display device, and the spatial information to which the display device belongs, and provide recommended information when the pre-stored information on the status of the preferred external audio device and the current status information of the external audio device included in the provided user interface are different from each other.

According to a display system according to at least one embodiment of the various embodiments of the present disclosure, the display system can include: a remote control device; an audio device; and a display device including the display, which is configured to provide information on the audio device, wherein the display device includes a processor that configures and outputs an external audio device information menu, when a first user input for the external audio device information menu is received, receives audio device information collected from an external audio device according to the first user input, and configures and outputs a user interface including at least one of current status information of the external audio device and control information for the external audio device based on the audio device information.

According to at least one embodiment of the operating method of a display device according to various embodiments of the present disclosure, the method can include: configuring and outputting an external audio device information menu; receiving a first user input for the external audio device information menu; receiving audio device information collected from an external audio device according to the first user input; and configuring and outputting a user interface including at least one of current status information of the external audio device and control information for the external audio device based on the audio device information.

### Effects of the Invention

According to at least one of the various embodiments of the present disclosure, there is an effect of being able to provide information on an external audio device through a display device.

According to at least one of the various embodiments of the present disclosure, there is an effect of being able to control an external audio device through a display device.

### BRIEF DESCRIPTION OF THE DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 illustrates an actual configuration example of a remote control device according to an embodiment of the present disclosure.

FIG. 4 illustrates an example of utilizing a remote control device according to an embodiment of the present disclosure.

FIG. 5 is a diagram for explaining a horizontal mode and a vertical mode of a stand-type display device according to an embodiment of the present disclosure.

FIG. 6 is a block diagram of a configuration of a display device according to another embodiment of the present disclosure.

FIG. 7 is a flowchart illustrating an operation method of a display device according to an embodiment of the present disclosure.

FIG. 8 is a diagram illustrating a user interface for providing volume information for an audio device in a display device according to an embodiment of the present disclosure.

FIG. 9 is a flowchart illustrating an example of an operation method between a remote control device, a display device, and an audio device in relation to FIG. 8.

FIG. 10 is a diagram illustrating an example of a definition of a control command in relation to FIG. 9.

FIG. 11 is a diagram illustrating a user interface for providing connection status information for an audio device in a display device according to an embodiment of the present disclosure.

FIG. 12 is a flowchart illustrating an example of an operation method between a remote control device, a display device, and an audio device in relation to FIG. 11.

FIG. 13 is a diagram illustrating an example of a definition of a control command in relation to FIG. 12.

FIG. 14 is a flowchart illustrating an example of an operation method between a remote control device, a display device, and an audio device in relation to providing connection status information of a wireless connection device for an audio device in a display device according to an embodiment of the present disclosure.

FIG. 15 is a diagram illustrating an example of a definition of a control command in relation to FIG. 14.

FIG. 16 is a flowchart illustrating an example of an operation method between a remote control device, a display device, and an audio device in relation to providing equalizer information of an audio device in a display device according to an embodiment of the present disclosure.

FIG. 17 is a diagram illustrating an operation related to providing information on an audio device according to conditions in a display device according to an embodiment of the present disclosure.

### BEST MODE

Hereinafter, embodiments related to the present invention will be described in more detail with reference to the drawings. The suffixes “module” and “part” used for components in the following description are given or used interchangeably only for the convenience of writing the specification, and do not have distinct meanings or roles in themselves.

The display device according to the embodiment of the present invention is, for example, an intelligent display device that adds a computer support function to the broadcast reception function, and while being faithful to the broadcast reception function, it can have an interface that is more convenient to use, such as a manual input device, a touch screen, or a space remote control, by adding an Internet function, etc. In addition, it can perform functions such as email, web browsing, banking, or games by connecting to the Internet and a computer with the support of wired or wireless Internet functions. A standardized general-purpose Operating System (OS) can be used for these various functions.

Therefore, the display device described in the present invention can perform various user-friendly functions, for example, since various applications can be freely added or deleted on a general-purpose OS kernel. The above display device can be, more specifically, a network TV, HBBTV, smart TV, LED TV, OLED TV, etc., and can be applied to a smartphone in some cases.

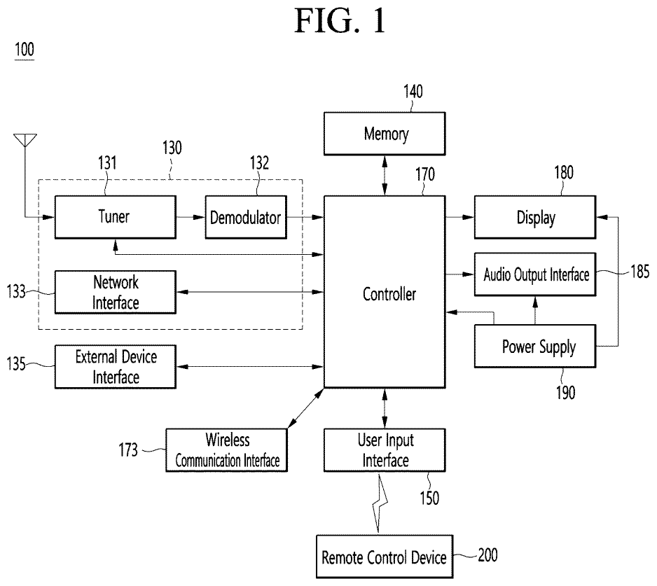

FIG. 1 is a block diagram illustrating the configuration of a display device according to an embodiment of the present invention.

Referring to FIG. 1, the display device 100 can include a broadcast receiving unit 130, an external device interface 135, a memory 140, a user input interface 150, a controller 170, a wireless communication interface 173, a display 180, a speaker 185, and a power supply circuit 190.

The broadcast receiving unit 130 can include a tuner 131, a demodulator 132, and a network interface 133.

The tuner 131 can select a specific broadcast channel according to a channel selection command. The tuner 131 can receive a broadcast signal for a specific broadcast channel that has been selected.

The demodulator 132 can separate the received broadcast signal into a video signal, an audio signal, and a data signal related to a broadcast program, and can restore the separated video signal, audio signal, and data signal into a form that can be output.

The external device interface 135 can receive an application or an application list in an adjacent external device and transmit it to the controller 170 or the memory 140.

The external device interface 135 can provide a connection path between the display device 100 and the external device. The external device interface 135 can receive one or more of images and audio output from an external device connected wirelessly or by wire to the display device 100 and transmit it to the controller 170. The external device interface 135 can include a plurality of external input terminals. The plurality of external input terminals can include an RGB terminal, one or more High Definition Multimedia Interface (HDMI) terminals, and a component terminal.

A video signal of an external device input through an external device interface 135 can be output through a display 180. A voice signal of an external device input through an external device interface 135 can be output through a speaker 185.

An external device that can be connected to the external device interface 135 can be any one of a set-top box (STB), a Blu-ray player, a DVD player, a game console, a sound bar, a smartphone, a PC, a USB memory, and a home theater, but this is only an example.

The network interface 133 can provide an interface for connecting the display device 100 to a wired/wireless network including the Internet. The network interface 133 can transmit or receive data with other users or other electronic devices through the connected network or another network linked to the connected network.

In addition, some content data stored in the display device 100 can be transmitted to other users or other electronic devices pre-registered in the display device 100 to selected users or selected electronic devices.

The network interface 133 can access a predetermined web page through the connected network or another network linked to the connected network. That is, it can access a predetermined web page through the network and transmit or receive data with the corresponding server.

In addition, the network interface 133 can receive content or data provided by a content provider or a network operator. That is, the network interface 133 can receive content such as movies, advertisements, games, VOD, broadcast signals, etc. and information related thereto provided from a content provider or a network provider through the network.

In addition, the network interface 133 can receive update information and update files of firmware provided by the network operator, and can transmit data to the Internet or content provider or network operator.

The network interface 133 can select and receive a desired application from among applications open to the public through the network.

The memory 140 can store programs for each signal processing and control within the controller 170, and can store processed images, voices, or data signals.

In addition, the memory 140 can perform a function for temporary storage of images, voices, or data signals input from an external device interface 135 or a network interface 133, and can store information about a given image through a channel memory function.

The memory 140 can store an application or an application list input from an external device interface 135 or a network interface 133.

The display device 100 can play content files (video files, still image files, music files, document files, application files, etc.) stored in the memory 140 and provide them to the user.

The user input interface 150 can transmit a signal input by the user to the controller 170 or transmit a signal from the controller 170 to the user. For example, the user input interface 150 can receive and process control signals such as power on/off, channel selection, and screen setting from the remote control device 200 according to various communication methods such as Bluetooth, Ultra Wideband (UWB), ZigBee, Radio Frequency (RF) communication method, or infrared (IR) communication method, or process the control signals from the controller 170 to be transmitted to the remote control device 200.

In addition, the user input interface 150 can transmit a control signal input from a local key (not shown) such as a power key, a channel key, a volume key, a setting value, etc. to the controller 170.

An image signal processed by the controller 170 can be input to the display 180 and displayed as an image corresponding to the image signal. In addition, an image signal processed by the controller 170 can be input to an external output device through an external device interface 135.

An audio signal processed by the controller 170 can be output as audio to a speaker 185. In addition, an audio signal processed by the controller 170 can be input to an external output device through an external device interface 135.

In addition, the controller 170 can control the overall operation within the display device 100.

In addition, the controller 170 can control the display device 100 by a user command or an internal program input through the user input interface 150, and can allow the user to download a desired application or application list into the display device 100 by connecting to a network.

The controller 170 allows the user-selected channel information, etc. to be output through the display 180 or speaker 185 together with the processed image or audio signal.

In addition, the controller 170 allows the image signal or audio signal from an external device, such as a camera or camcorder, input through the external device interface 135 according to the external device image playback command received through the user input interface 150 to be output through the display 180 or speaker 185.

Meanwhile, the controller 170 can control the display 180 to display an image, and for example, can control a broadcast image input through the tuner 131, an external input image input through the external device interface 135, an image input through the network interface, or an image stored in the memory 140 to be displayed on the display 180. In this case, the image displayed on the display 180 can be a still image or a moving image, and can be a 2D image or a 3D image.

In addition, the controller 170 can control the content stored in the display device 100, or the received broadcast content, or the external input content input from the outside to be played, and the content can be in various forms such as a broadcast image, an external input image, an audio file, a still image, a connected web screen, a document file, etc.

The wireless communication interface 173 can perform communication with an external device through wired or wireless communication. The wireless communication interface 173 can perform short range communication with an external device. To this end, the wireless communication interface 173 can support short range communication using at least one of Bluetooth™, Radio Frequency Identification (RFID), Infrared Data Association (IrDA), UWB, ZigBee, Near Field Communication (NFC), Wireless-Fidelity (Wi-Fi), Wi-Fi Direct, and Wireless Universal Serial Bus (Wireless USB) technologies. The wireless communication interface 173 can support wireless communication between the display device 100 and a wireless communication system, between the display device 100 and another display device 100, or between the display device 100 and a network where the display device (100, or an external server) is located through a short-range wireless communication network (Wireless Area Networks). The short-range wireless communication network can be a short-range wireless personal area network (Wireless Personal Area Networks).

Here, the other display device 100 can be a wearable device (e.g., a smart watch, smart glass, a head mounted display (HMD)) or a mobile terminal such as a smart phone that can exchange data with the display device 100 according to the present invention (or can be linked). The wireless communication interface 173 can detect (or recognize) a wearable device capable of communication around the display device 100.

Furthermore, if the detected wearable device is a device authenticated to communicate with the display device 100 according to the present invention, the controller 170 can transmit at least a part of the data processed in the display device 100 to the wearable device through the wireless communication interface 173. Therefore, the user of the wearable device can use the data processed in the display device 100 through the wearable device.

The display 180 can convert an image signal, a data signal, an OSD signal processed in the controller 170 or the image signal, data signal received from the external device interface 135 into R, G, B signals, respectively, to generate a driving signal.

Meanwhile, the display device 100 illustrated in FIG. 1 is only an embodiment of the present invention. Some of the illustrated components can be integrated, added, or omitted according to the specifications of the display device 100 actually implemented.

That is, two or more components can be combined into one component, or one component can be subdivided into two or more components, as needed. In addition, the functions performed by each block are for explaining an embodiment of the present invention, and the specific operations or devices thereof do not limit the scope of the rights of the present invention.

According to another embodiment of the present invention, the display device 100 can receive and play back images through a network interface 133 or an external device interface 135 without having a tuner 131 and a demodulator 132 as shown in FIG. 1.

For example, the display device 100 can be implemented separately as an image processing device, such as a set-top box, for receiving contents according to broadcast signals or various network services, and a content playback device for playing back contents input from the image processing device.

In this case, the operation method of the display device according to the embodiment of the present invention to be described below can be performed by any one of the image processing device, such as the set-top box, or the content playback device having the display 180 and the audio output unit 185, as well as the display device 100 described with reference to FIG. 1.

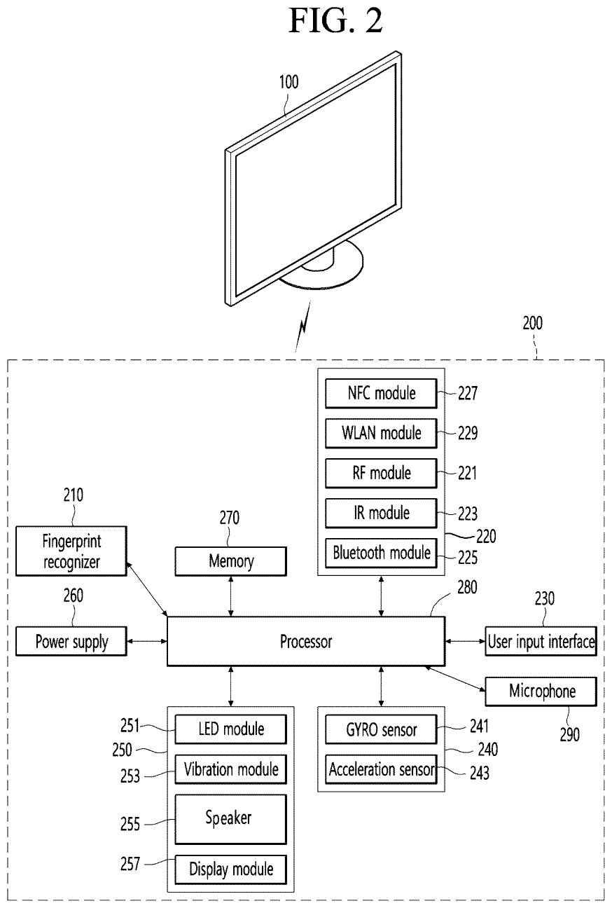

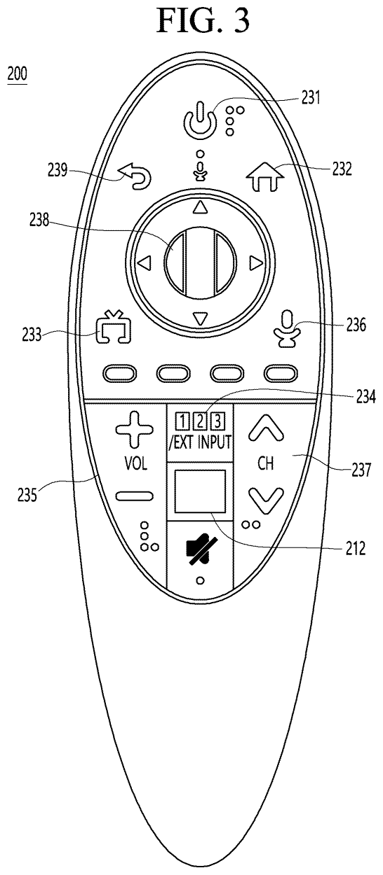

Next, with reference to FIGS. 2 and 3, a remote control device according to an embodiment of the present invention will be described.

FIG. 2 is a block diagram of a remote control device according to an embodiment of the present invention, and FIG. 3 illustrates an example of an actual configuration of a remote control device 200 according to an embodiment of the present invention.

First, with reference to FIG. 2, the remote control device 200 can include a fingerprint recognition device 210, a wireless communication circuit 220, a user input interface 230, a sensor 240, an output interface 250, a power supply circuit 260, a memory 270, a controller 280, and a microphone 290.

With reference to FIG. 2, the wireless communication circuit 220 transmits and receives signals with any one of the display devices 100 according to the embodiments of the present invention described above.

The remote control device 200 can be equipped with an RF circuit 221 capable of transmitting/receiving signals with the display device 100 according to RF communication standards, and an IR circuit 223 capable of transmitting/receiving signals with the display device 100 according to IR communication standards. In addition, the remote control device 200 can be equipped with a Bluetooth circuit 225 capable of transmitting/receiving signals with the display device 100 according to Bluetooth communication standards. In addition, the remote control device 200 can be equipped with an NFC circuit 227 capable of transmitting/receiving signals with the display device 100 according to Near Field Communication (NFC) communication standards, and a WLAN circuit 229 capable of transmitting/receiving signals with the display device 100 according to Wireless LAN (WLAN) communication standards.

In addition, the remote control device 200 transmits a signal containing information about the movement of the remote control device 200 to the display device 100 through the wireless communication circuit 220.

Meanwhile, the remote control device 200 can receive a signal transmitted by the display device 100 through the RF circuit 221, and, if necessary, can transmit commands for power on/off, channel change, volume change, etc. to the display device 100 through the IR circuit 223.

The user input interface 230 can be composed of a keypad, a button, a touch pad, or a touch screen. The user can input a command related to the display device 100 to the remote control device 200 by operating the user input interface 230. If the user input interface 230 is equipped with a hard key button, the user can input a command related to the display device 100 to the remote control device 200 through a push operation of the hard key button. This will be described with reference to FIG. 3.

Referring to FIG. 3, the remote control device 200 can include a plurality of buttons. The plurality of buttons can include a fingerprint recognition button 212, a power button 231, a home button 232, a live button 233, an external input button 234, a volume control button 235, a voice recognition button 236, a channel change button 237, a confirmation button 238, and a back button 239.

The fingerprint recognition button 212 can be a button for recognizing a user's fingerprint. In one embodiment, the fingerprint recognition button 212 can be capable of a push operation, and can receive a push operation and a fingerprint recognition operation.

The power button 231 can be a button for turning the power of the display device 100 on/off.

The home button 232 can be a button for moving to the home screen of the display device 100.

The live button 233 can be a button for displaying a real-time broadcast program.

The external input button 234 can be a button for receiving an external input connected to the display device 100.

The volume control button 235 can be a button for adjusting the size of the volume output by the display device 100.

The voice recognition button 236 can be a button for receiving a user's voice and recognizing the received voice.

The channel change button 237 can be a button for receiving a broadcast signal of a specific broadcast channel.

The confirmation button 238 can be a button for selecting a specific function, and the back button 239 can be a button for returning to the previous screen.

FIG. 2 will be described again.

If the user input interface 230 has a touch screen, the user can input a command related to the display device 100 to the remote control device 200 by touching the soft key of the touch screen. In addition, the user input interface 230 can have various types of input means that the user can operate, such as a scroll key or a jog key, and this embodiment does not limit the scope of the rights of the present disclosure.

The sensor 240 can have a gyro sensor 241 or an acceleration sensor 243, and the gyro sensor 241 can sense information about the movement of the remote control device 200.

For example, the gyro sensor 241 can sense information about the operation of the remote control device 200 based on the x, y, and z axes, and the acceleration sensor 243 can sense information about the movement speed of the remote control device 200. Meanwhile, the remote control device 200 can further be equipped with a distance measuring sensor, so as to sense the distance to the display 180 of the display device 100.

The output interface 250 can output a video or audio signal corresponding to the operation of the user input interface 230 or the signal transmitted from the display device 100.

The user can recognize whether the user input interface 230 is being operated or whether the display device 100 is being controlled through the output interface 250.

For example, the output interface 250 can be equipped with an LED 251 that lights up when the user input interface 230 is operated or a signal is transmitted and received with the display device 100 through the wireless communication unit 225, a vibrator 253 that generates vibration, a speaker 255 that outputs sound, or a display 257 that outputs an image.

In addition, the power supply circuit 260 supplies power to the remote control device 200, and power waste can be reduced by stopping the power supply when the remote control device 200 does not move for a predetermined period of time.

The power supply circuit 260 can resume the power supply when a predetermined key provided in the remote control device 200 is operated.

The memory 270 can store various types of programs, application data, etc. required for the control or operation of the remote control device 200.

When the remote control device 200 wirelessly transmits and receives signals through the display device 100 and the RF circuit 221, the remote control device 200 and the display device 100 transmit and receive signals through a predetermined frequency band.

The controller 280 of the remote control device can store and refer to information about the frequency band that can wirelessly transmit and receive signals with the display device 100 paired with the remote control device 200 in the memory 270.

The controller 280 controls all matters related to the control of the remote control device 200. The controller 280 can transmit a signal corresponding to a predetermined key operation of the user input interface 230 or a signal corresponding to the movement of the remote control device 200 sensed by the sensor 240 to the display device 100 through the wireless communication unit 225.

In addition, the microphone 290 of the remote control device 200 can acquire voice.

A plurality of microphones 290 can be provided.

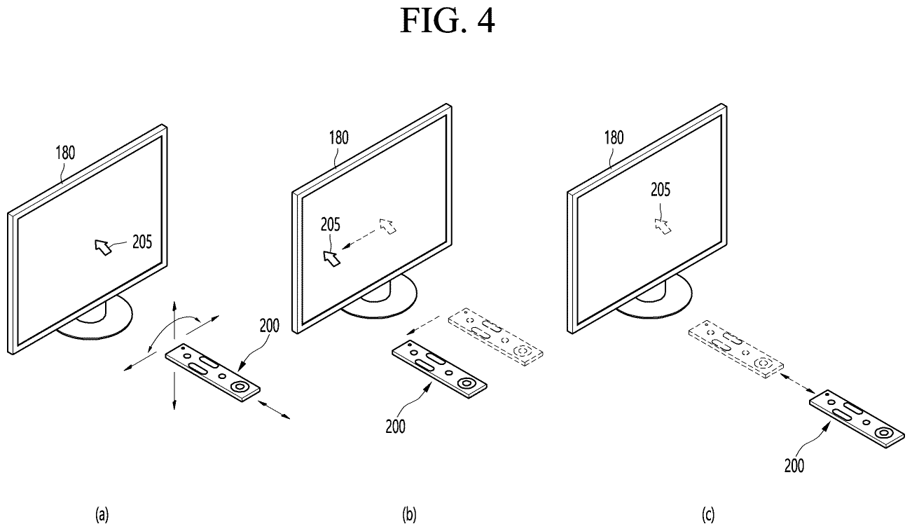

Next, FIG. 4 is described.

FIG. 4 illustrates an example of utilizing a remote control device 200 according to an embodiment of the present invention.

FIG. 4(a) illustrates that a pointer 205 corresponding to a remote control device 200 is displayed on a display 180.

A user can move or rotate the remote control device 200 up and down, left and right. The pointer 205 displayed on the display 180 of the display device 100 corresponds to the movement of the remote control device 200. This remote control device 200 can be named a ‘space remote control’ because the pointer 205 moves and is displayed according to the movement in 3D space, as shown in the drawing.

FIG. 4(b) exemplifies that when a user moves the remote control device 200 to the left, the pointer 205 displayed on the display 180 of the display device 100 also moves to the left in response.

Information about the movement of the remote control device 200 detected by the sensor of the remote control device 200 is transmitted to the display device 100. The display device 100 can calculate the coordinates of the pointer 205 from the information about the movement of the remote control device 200. The display device 100 can display the pointer 205 in response to the calculated coordinates.

FIG. 4(c) exemplifies a case where a user moves the remote control device 200 away from the display 180 while pressing a specific button in the remote control device 200. By this, the selection area in the display 180 corresponding to the pointer 205 can be zoomed in and displayed in an enlarged manner.

Conversely, when the user moves the remote control device 200 closer to the display 180, the selection area in the display 180 corresponding to the pointer 205 can be zoomed out and displayed in a reduced manner.

Meanwhile, when the remote control device 200 moves away from the display 180, the selection area can be zoomed out, and when the remote control device 200 moves closer to the display 180, the selection area can be zoomed in.

In addition, when a specific button in the remote control device 200 is pressed, the recognition of up, down, left, and right movements can be excluded. That is, when the remote control device 200 moves away from or closer to the display 180, the up, down, left, and right movements can be recognized only, and only the forward and backward movements can be recognized. When a specific button in the remote control device 200 is not pressed, only the pointer 205 moves according to the up, down, left, and right movements of the remote control device 200.

Meanwhile, the moving speed or moving direction of the pointer 205 can correspond to the moving speed or moving direction of the remote control device 200.

Meanwhile, the pointer in this specification refers to an object displayed on the display 180 in response to the operation of the remote control device 200. Therefore, in addition to the arrow shape shown in the drawing, the pointer 205 can be an object of various shapes, for example, a concept including a point, a cursor, a prompt, a thick outline, etc. In addition, the pointer 205 can be displayed corresponding to one point of the horizontal and vertical axes on the display 180, and can also be displayed corresponding to multiple points such as a line or a surface.

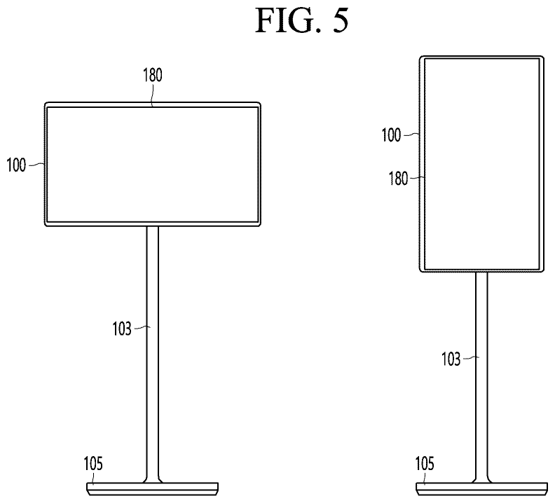

FIG. 5(a) and FIG. 5(b) are drawings for explaining the horizontal mode and the vertical mode of the stand-type display device according to the embodiment of the present disclosure.

Referring to FIG. 5(a) and FIG. 5(b), a stand-type display device 100 is illustrated.

A shaft 103 and a stand base 105 can be connected to the display device 100.

The shaft 103 can connect the display device 100 and the stand base 105. The shaft 103 can be extended vertically.

The lower end of the shaft 103 can be connected to the edge of the stand base 105.

The lower end of the shaft 103 can be rotatably connected to the periphery of the stand base 105.

The display device 100 and the shaft 103 can rotate around a vertical axis relative to the stand base 105.

The upper portion of the shaft 103 can be connected to the rear of the display device 100.

The stand base 105 can serve to support the display device 100.

The display device 100 can be configured to include the shaft 103 and the stand base 105.

The display device 100 can rotate around a point where the upper portion of the shaft 103 and the rear of the display 180 meet.

FIG. 5(a) illustrates that the display 180 operates in a landscape mode in which the horizontal length is greater than the vertical length, and FIG. 5(b) illustrates that the display 180 operates in a landscape mode in which the vertical length is greater than the horizontal length.

The user can carry and move the stand-type display device. That is, unlike fixed devices, the stand-type display device 100 has improved mobility, so the user is not restricted by the placement location.

In the past, in order to control an external audio device, i.e., a speaker, it was controlled through a dedicated external speaker control device or a button provided on an external speaker, so there was inconvenience in using it.

In the following, the present disclosure provides information on an external audio device 300 that can be connected to or is connected to the display device 100 through a display 180 in the display device 100, and describes various embodiments of a control operation for the audio device 300. In this regard, for a description of a part that overlaps with the description of the aforementioned FIGS. 1 to 5, reference is made to the aforementioned content, except where necessary, and the following description is omitted. For example, for a description of the configuration and function of the display device 100 and the remote control device 200 (e.g., a remote control), reference can be made to at least one of the descriptions of FIGS. 1 to 5 described above.

In relation to this, the ‘audio device information’ described in the present disclosure can indicate or include at least one of, for example, information on the volume level or volume value (hereinafter, referred to as ‘volume level’ for convenience) of the audio device 300, connection status information of the audio device 300, status information of a device (or dongle) for wireless connection between the display device 100 and the audio device 300, equalizer (or audio effect) information of the audio device, etc.

In the above, the display device 100 outputs audio device information on the screen, and the user can access information about the audio device 300 output through the screen of the display device 100 via the remote control device 200 to indirectly request a control operation for the audio device 300.

The display device 100 can provide the user with audio device information or, through it, provide information for controlling the external audio device 300 in the form of a menu. If there is a button for the corresponding menu on the remote control device 200, this can be provided immediately upon access to the corresponding button, or, if not, it can be provided in the form of a submenu of the audio-related menu, and can be provided when entering through the audio-related menu.

Meanwhile, the audio device 300 below can be configured as, for example, a main audio device (or main body) and an auxiliary audio device. The main audio device can be named a sound bar and can be equipped with multiple speakers (e.g., up-firing). The auxiliary audio device can include at least one sub-woofer supporting low and medium sounds, at least one rear speaker supporting three-dimensional sound, etc. The rear speaker can include multiple up-firing speakers and multiple surround speakers. Through this, the audio device 300 can support, for example, 9.1.5 channels.

In the present disclosure, a wired or wireless connection is possible between the display device 100 and the audio device 300 and/or the main audio device and the auxiliary audio device, and in particular, a dongle (e.g., an HDMI dongle, etc.) can be used for wireless connection.

Meanwhile, the High-Definition Multimedia Interface-Consumer Electronics Control (HDMI-CEC) protocol can be used for signal transmission and reception or data communication between the two devices, but this is only an example and the present disclosure is not limited thereto.

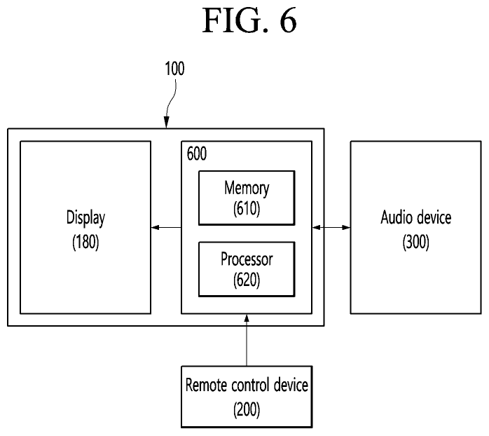

FIG. 6 is a block diagram of a display device 100 according to another embodiment of the present disclosure.

The display device 100 can be configured to include a display 180 and a processing unit 600.

The processing unit 600 can be configured to include a memory 610 and a processor 620. The processing unit 600 can process data exchanged with the audio device 300 through the HDMI protocol.

The memory 610 can store various data. The memory 610 can store data received or processed by the processing unit 600.

The memory 610 can store information related to the external audio device 300 received or processed by the processing unit 600.

The memory 610 stores various information, such as information on the configuration of an external audio device 300 information menu that can be processed by the processing unit 600 or the processor 620 and output through the display 180, information on the mapping operation of the corresponding display device 100 when accessing the external audio device 300 information menu through the remote control device 200, and can be read and used by the processor 620, etc.

The processor 620 can perform processing, control, etc. for overall data communication, user interface configuration and provision, control operation, etc. between the remote control device 200 and the external audio device 300 according to the present disclosure. The processor 620 can have the same configuration as the controller 170 of FIG. 1, for example.

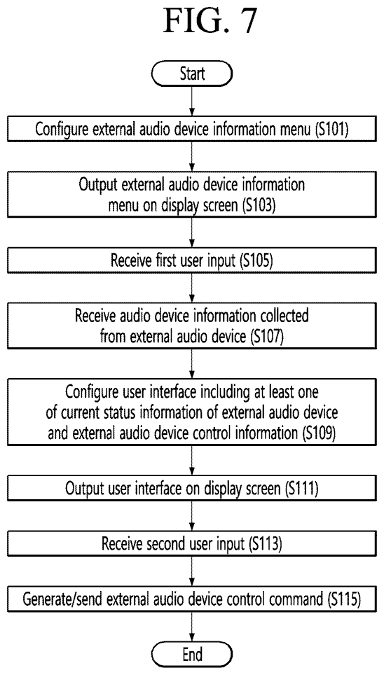

FIG. 7 is a flowchart illustrating an operation method of a display device 100 according to an embodiment of the present disclosure.

The display device 100 can configure an external audio device information menu (S101).

The display device 100 can output the external audio device information menu on the display 180 screen (S103).

The display device 100 can receive a first user input for the external audio device information menu through a remote control device 200 (S105).

The display device 100 can receive audio device information collected from an external audio device 300 according to the first user input (S107).

The display device 100 can configure a user interface including current status information of an external audio device 300 and control information for the external audio device based on audio device information (S109).

The display device 100 can output the user interface on the display 180 screen (S111).

The display device 100 can receive a second user input for the user interface through a remote control device 200 (S113).

The display device 100 can generate and transmit a control command for the external audio device based on the second user input (S115).

According to one embodiment, the configuration and output of the external audio device information menu in steps S101 to S103 can be omitted.

According to another embodiment, the configuration and output of the external audio future information menu in steps S101 to S103 can be performed based on audio device information collected by the external audio device 300 and received by the display device 100 after receiving the first user input in step S105, unlike as illustrated in FIG. 7.

The audio device information described in the present disclosure mainly indicates information about the main audio device, but can include information about an auxiliary audio device in some cases.

Hereinafter, the operation of the display device 100 for each information processing that constitutes the audio device information will be described. Each piece of information can include each piece of information that constitutes the aforementioned audio device information, i.e., information on the volume (value) of the audio device 300, connection status information of the audio device 300, status information of a (wireless) connection device for the audio device 300, equalizer (or audio effect) information of the audio device 300, etc.

First, the operation for processing information on the volume (value) of the audio device 300 as one of the audio device information is described as follows.

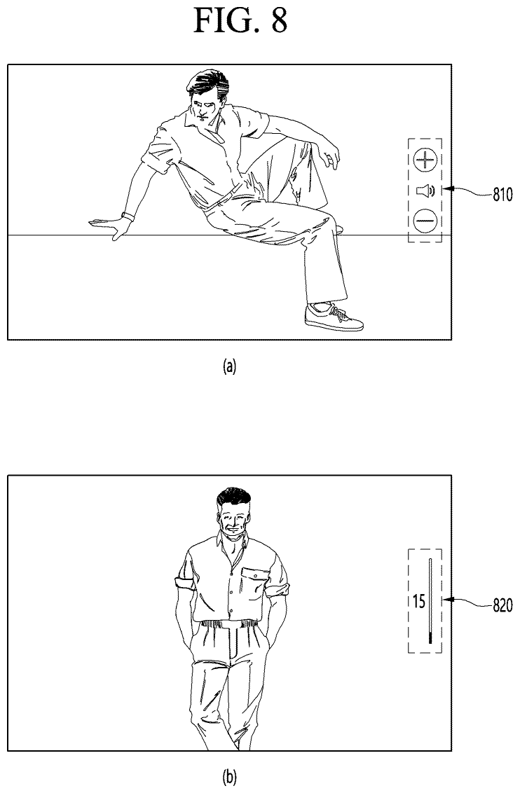

FIG. 8 is a drawing illustrating a user interface for providing volume information on the audio device 300 in a display device 100 according to an embodiment of the present disclosure.

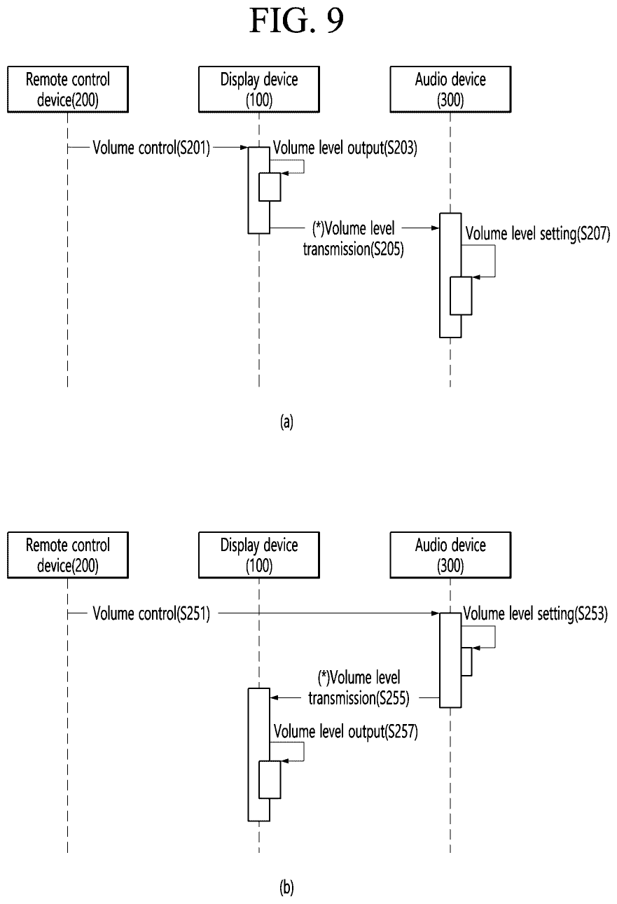

FIG. 9 is a flowchart illustrating an example of an operation method between a remote control device 200, a display device 100, and an audio device 300 in relation to FIG. 8.

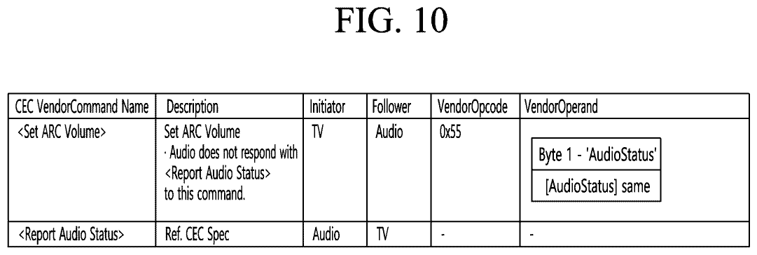

FIG. 10 is a drawing illustrating an example of a definition of a control command in relation to FIG. 9.

In FIG. 8(a), the volume information 810 of the audio device 300 is provided on the screen of the display device 100, but since the audio device or its manufacturer arbitrarily defines the volume level or range, the display device 100 only provides information on whether the volume is changed (e.g., ‘+’, ‘−’, mute). The volume level range can indicate any one of the ranges in which the volume level can be adjusted (e.g., 0-100, 50-200, etc.), the ranges in which the display device 100 or the audio device 300 can support or process audio volume, etc.

Therefore, when the user requests a change in the volume (level) of the audio device 300 through the remote control device 200 (e.g., audio key (‘+’)), the volume control of the audio device 300 through the display device 100 cannot be controlled as the user intended.

Since the user cannot recognize the current volume level of the audio device 300, there is inconvenience in using it. In addition, since the user cannot know how much the volume level changes with one volume control, the user can experience trial and error to control the desired volume.

In addition, even with the same request, since the processing for volume change is different for each audio device 300, it can be very difficult for the user to adjust the audio volume as desired.

Meanwhile, in FIG. 8(b), volume information 820 of the audio device 300 is shown on the screen of the display device 100. The volume information 820 can include graph information on the volume level range of the corresponding audio device 300 and information indicating the current audio volume level. In addition, when the display device 100 provides the volume information 820 shown in FIG. 8(b), it can also provide volume level information that changes according to a one-time volume up/down request. The volume level information can be expressed in the form of decibels (dB).

For example, suppose that the first audio device has an audio volume level range of 0 -150 (the current volume level is 75) and the second audio device has an audio volume level range of 0 -200 (the current volume level is 75).

According to an embodiment, referring to FIG. 8(b), the display device 100 can display graph information on the volume level range as ‘0-100’ and display current audio volume level information as ‘50’ for both the first audio device and the second audio device.

According to another embodiment, referring to FIG. 8(b), the display device 100 can display the current audio volume level information as ‘75’ and the graph information for the volume level range as ‘0-150’ for the first audio device, and display the current audio volume level information as ‘100’ and the graph information for the volume level range as ‘0-200’ for the second audio device.

Therefore, the user can intuitively and accurately perform audio volume control through the current audio volume level information and the graph information.

As described above, the volume information (volume level and volume level range) of the audio device 300 output from the display device 100 can be different from the volume information of the actual audio device 300, and in this case, synchronization of the volume information of the two devices is required. This is because the volume level displayed on the display device 100 and the volume intensity actually output from the audio device 300 must match.

FIG. 9(a) is a drawing for a case where a user controls (e.g., indirectly controls) the volume of an audio device 300 on a display device 100 through a remote control device 200, and FIG. 9(b) is a drawing for a case where a user controls the volume of an audio device 300.

First, referring to FIG. 9(a), the display device 100 can receive a user's volume control (volume up/down control request) signal through the remote control device 200 (S201).

The display device 100 can output a volume level in response to receiving the user's volume control signal (S203).

The display device 100 can transmit the volume level output in step S203 to the audio device 300 (S205).

The audio device 300 can set the volume level transmitted through the display device 100 at step S205 (S207).

The volume level output from the display device 100 at step S203 can be determined based on the volume level received from the audio device 300 before step S201. When the display device 100 receives the volume level from the audio device 300, it can change it to a volume level to be provided to the user based on a predefined volume level range as described above and then provide it.

In response to the volume manipulation control signal requested from the remote control device 200 in step S201, the display device 100 can transmit a volume level corresponding to the additional volume manipulation control signal to the audio device 300 in step S205, if an additional volume manipulation control signal is received from the remote control device 200 in step S203 (volume manipulation (increase/decrease) buttons are also provided).

The volume level corresponding to the additional volume manipulation control signal can be a difference value according to the increase/decrease in the volume level compared to the previous one.

Meanwhile, even if the volume level control, i.e., the increase/decrease in the audio device 300 is set to, for example, the first unit (for example, 10 dB unit), the display device 100 can provide a service to the user so that the volume level is controlled in the same unit as the audio device 300, i.e., in the first unit, or not. For example, as described above, even if the audio device 300 is set to control the volume level by the first unit, the display device 100 can provide a service to the user so that the volume level can be controlled by the second unit (for example, by 5 dB). In this case, when a volume control request operation is received from the remote control device 200 by the second unit, the display device 100 can transmit a signal so that the volume level of the audio device 300 can be adjusted to a volume level corresponding to the operation.

Alternatively, the display device 100 can provide a volume control button, and provide a service so that the unit (or range) of the volume level increased or decreased by pressing the volume control button once matches the volume control increase or decrease unit set by the audio device 300.

Next, referring to FIG. 9(b), a volume control signal can be directly transmitted from the remote control device 200 to the audio device 300 (S251). The S251 step is not necessarily executed by the remote control device 200, but can also be executed by the user directly pressing or touching the volume control button provided on the audio device 300.

The audio device 300 can set a volume level corresponding to the volume control signal received from the remote control device 200 in the S251 step (S253).

When the volume level is set in the S253 step, the audio device 300 can transmit the set volume level information to the display device 100 so that the currently set volume level can be provided through the screen of the display device 100 for the convenience of the user (S255).

The display device 100 can determine and generate a volume level to be output based on the volume level received from the audio device 300 in the S255 step, and then output it through the screen (S257). Step S257 can be executed only when a volume level information request manipulation signal is received from the remote control device 200 in the display device 100 or whenever the volume level information is updated from the audio device 300, and can be output through the screen. Here, update can refer to a case where the previously set volume level and the set volume level are different.

The volume level output through the screen in step S257 by the display device 100 can be output as is the volume level transmitted from the audio device 300, or can be a value adjusted to the volume level range set by the display device 100 as described above.

FIG. 10 is a diagram illustrating a method of transmitting a volume level from the display device 100 to the audio device 300 in step S205 of FIG. 9(a), and a method of transmitting a volume level from the audio device 300 to the display device 100 in step S255 of FIG. 9(b).

According to one embodiment, in the present disclosure, in step S205 of FIG. 9(a) and step S255 of FIG. 9(b), the HDMI-CEC protocol can be used between the display device 100 and the audio device 300. However, it is not limited thereto.

As an example of FIG. 10, the device 100, 300 uses vendor command information of the HDMI-CEC protocol, but it is not limited thereto. For example, new information other than vendor command information can be configured and used.

Referring to FIG. 10, the device 100, 300 uses ‘Set ARC Volume’ information and ‘Report Audio Status’ information in the vendor command information as an example. ‘Set ARC Volume’ information indicates information for setting the ARC (Auto Return Channel) volume.

‘Set ARC Volume’ information can be generated by the display device 100 at step S205 of FIG. 9(a) and transmitted to the audio device 300. At this time, the value (VedorOpcode) of the ‘Set ARC Volume’ information can be assigned a value of ‘0x55’ , but is not limited thereto. Meanwhile, the ‘Set ARC Volume’ information (VendorOperand) can be assigned 1 byte, but is not limited thereto.

‘Report Audio Status’ information represents information for enabling the display device 100 to output audio status information.

‘Report Audio Status’ information can be generated by the audio device 300 at step S255 of FIG. 9(b) and transmitted to the display device 100. The content regarding the ‘Report Audio Status’ information can be used as defined in the HDMI-CEC specification, but is not necessarily limited thereto.

Meanwhile, in FIG. 9(a) or 9(b), when a volume manipulation signal is input to the display device 100 or audio device 300 by the remote control device 200, the audio device 300 or the display device 100 can transmit (or share) the volume manipulation signal input by the remote control device 200, and in this case, the HDMI-CEC protocol (e.g., ‘User Control Pressed information’, etc.) can also be used between the display device 100 and the audio device 300. The device 100 or 300 that received the volume manipulation signal by the remote control device 200 can perform a related operation.

Next, the operation for processing the connection status information of the audio device 300 as one of the audio device information is described as follows.

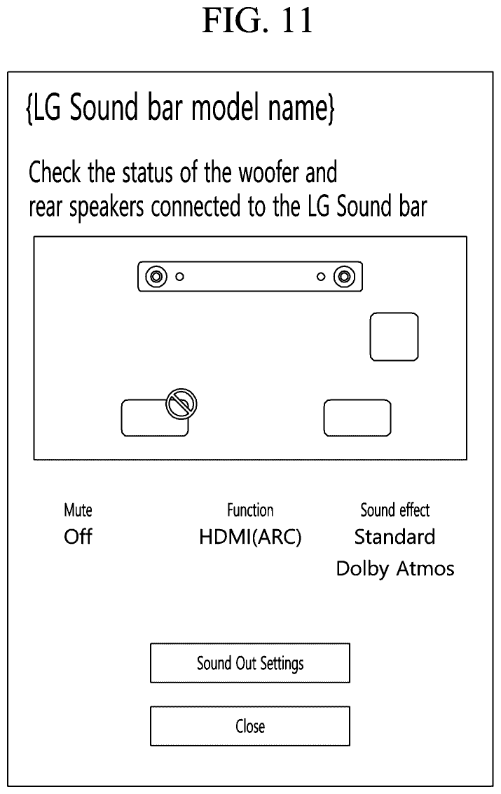

FIG. 11 is a diagram illustrating a user interface for providing connection status information of the audio device 300 in a display device 100 according to an embodiment of the present disclosure.

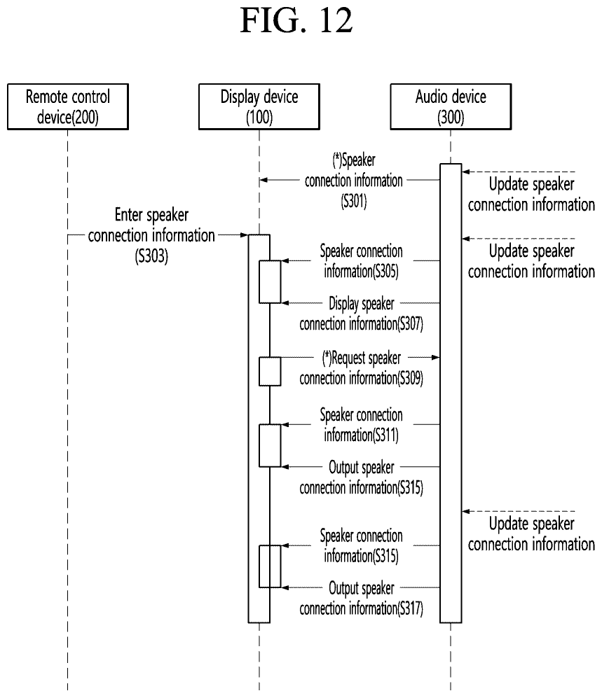

FIG. 12 is a flowchart illustrating an example of an operation method between a remote control device 200, a display device 100, and an audio device 300 in relation to FIG. 11.

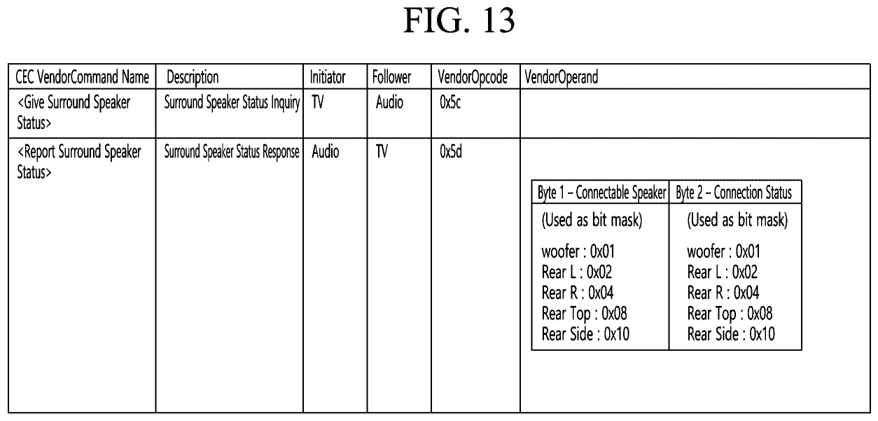

FIG. 13 is a diagram illustrating an example of a definition of a control command in relation to FIG. 12.

As described above, the audio device can be a kind of set (SET) configuration configured by including a main audio device and an auxiliary audio device.

For convenience of explanation, the main audio device is described as a sound bar, and the auxiliary audio device is described as at least one woofer or subwoofer and at least one rear speaker as an example. However, the present disclosure is not limited thereto.

FIG. 11 is a diagram illustrating information regarding the connection status of the main audio device and the auxiliary audio device.

Referring to FIG. 11, the display device 100 can output connection status information of the audio device 300 on the screen and provide it to the user.

In one area of the user interface screen illustrated in FIG. 11, name (or model name) identification information for the audio device can be provided. According to one embodiment, the name (or model name) identification information for the audio device can be provided only as identification information for the main audio device. According to another embodiment, identification information for the main audio device and the auxiliary audio device can be provided together. According to another embodiment, identification information set by the user (e.g., wireless audio device, audio device of user A, etc.) including the main and auxiliary audio devices can be provided, which can be changed. However, the present disclosure is not limited to the above-described example.

Referring to FIG. 11, information on a set configuration of audio devices and information on a connection status between the configurations within the set (e.g., the main audio device and the auxiliary audio device) can be provided in another area of the user interface screen.

The connection status information can be provided in the form of an image, as illustrated in FIG. 11. However, the present disclosure is not limited thereto. For example, the display device 100 can provide the type or identification information of an auxiliary audio device connected to the main audio device and a connection status confirmation message thereof as text data, and the connection status information in the form of the image described above can also be provided together.

For convenience, in FIG. 11, one main audio device and three auxiliary audio devices are illustrated as constituting an external audio device, and one of the auxiliary audio devices is illustrated so that it can be identified that it is not connected to the main audio device. For example, identification information for each audio device configuration (e.g., main body (or sound bar), subwoofer, rear speaker 1, 2, etc.) in the image-type information can be provided, line information for connection can be provided, and the line can be disconnected depending on the connection status, etc.

Another area of the user interface screen illustrated in FIG. 11 can provide information on mute (e.g., Mute off), function (e.g., HDMI (ARC), etc.), sound effect (e.g., Standard Dolby Atmos), and a button for Sound Out Settings. However, this is not limited thereto.

Meanwhile, each audio device can be individually selected from the user interface screen illustrated in FIG. 11. Therefore, when a specific audio device configuration is selected, the display device 100 can change the information previously provided in the user interface described above to information about the selected specific audio device. Therefore, the user can request a control operation for the corresponding audio device configuration based on the changed information provided.

When the connection status information is provided in the form of an image at the bottom of the identification information in the user interface screen, the arrangement or location of each audio device configuration can be determined and provided based on the actual arrangement or location.

The configuration of the user interface screen of FIG. 11 is only an example and is not limited thereto.

The user interface as shown in FIG. 11 can be provided to the user through the screen of the display device 100.

Therefore, the display device 100 can receive the connection status information collected from the audio device 300 and configure and provide the user interface as shown in FIG. 11 based on the connection status information.

Referring to FIG. 12, a data communication process regarding the connection status of the audio device 300 between the display device 100 and the audio device 300 is illustrated.

In FIG. 12, the audio device 300 is explained assuming, for example, the main audio device, i.e., the main body (sound bar), but is not limited thereto.

The audio connection status information can indicate information regarding the connection status between the main audio device and the auxiliary audio device.

Regardless of the data communication between the display device 100, the remote control device 200, and the audio device 300 illustrated in FIG. 12, if there is a change in the connection status information with the audio device 300, the auxiliary audio device can update the change information by transmitting it to the audio device 300. The audio device 300 can transmit the updated audio connection status information to the display device 100. According to one embodiment, when transmitting audio connection status information to the display device 100, the audio device 300 can transmit updated audio connection status information whenever the audio connection status information is updated. According to another embodiment, the audio device 300 can temporarily store the updated audio connection status information whenever the audio connection status information is updated, and transmit it only when the display device 100 requests speaker connection information (S309). In this case, the transmitted speaker connection information can include the most recently updated speaker connection status information or all speaker connection status information updated after the previous request.

As described above, when the display device 100 receives updated speaker connection information from the audio device 300 (S305), the display device 100 can store it. In this case, when each speaker connection information is received, the display device 100 can check whether the user enters the speaker connection information menu through the remote control device 200. The display device 100 can immediately output the speaker connection status information received and stored in step S305 (S307) if the speaker connection information menu is activated as in step S303 as a result of the verification.

Meanwhile, steps S309 to S313 can be processes in which a specific event is detected or periodically performed. The specific event can include step S303 described above. For example, the display device 100 can already output the speaker connection status information received in step S305 in step S307 even if there is no separate request after step S303, but can be a procedure to further check whether there is additional speaker connection information update.

In addition, even if the display device 100 has already output the speaker connection status information in step S307 or outputs the speaker connection status information again through steps S309 to S313, the display device 100 can receive the updated speaker connection status information from the audio device 300 (S315). However, the display device 100 can immediately output and provide the speaker connection status information received in step S315 to the user if the speaker connection information menu entry is not yet released (S317).

Meanwhile, referring to FIG. 12, if the display device 100 receives updated speaker connection information according to the speaker connection information update through the audio device 300 in step S301, it can store the updated speaker connection information and, unlike step S305, cannot immediately output it. However, it is not limited thereto. For example, since a user using the display device 100 cannot know that the speaker connection status has been updated, if the updated information is received through the audio device 300, regardless of whether the user enters the speaker connection information through the remote control device 200, the updated speaker connection status information can be provided in an area of the screen, whether the speaker connection status information has been updated, and the updated speaker connection status information.

Meanwhile, the speaker connection information output in step S317 can be in the form of the user interface of FIG. 11 described above.

In the above, a specific event can mean a case where an interrupt, such as a user's input through the remote control device 200, an audio output abnormality, etc., occurs. For example, a user's input through the remote control device 200 can include a command to change an input mode, change a channel, request audio device information, call a home dashboard/app list, etc. An audio output abnormality can indicate, for example, a disconnection due to a network error between the display device 100 and the audio device 300, an abnormality in at least one of the configurations of the audio device 300, an increase above a threshold or a decrease below a threshold in the audio level, etc.

The display device 100 can repeatedly perform the audio connection status information request of step S309 from the audio device 300 periodically/aperiodically until a response to the corresponding request of step S311 is received, for example. The audio device 300 can return the audio connection status information in response to each information request of the display device 100, or can return it only when there is an update of the audio connection status information.

When the display device 100 receives the audio connection status information from the audio device 300 according to the transmission of the audio connection status information request of step S309 or according to the update of the audio connection status information (S311), the display device 100 can output the audio connection status information on the screen (S313).

The display device 100 can perform the same operation as the above-described steps S311 to S313 whenever the audio connection status information is updated (S315, S317).

FIG. 13 is a diagram illustrating an operation of exchanging audio connection status information between a display device 100 and an audio device 300 according to an update of the connection status information of an audio device in FIG. 12.

As described above in FIG. 10, in FIG. 13, an HDMI-CEC protocol can be used between the display device 100 and the audio device 300, and vendor command information of the HDMI-CEC protocol can be used. However, the present invention is not limited thereto.

Referring to FIG. 13, as an example, the devices 100, 300 use ‘Report Surround Speaker Status’ information and ‘Give Surround Speaker Status’ information in the vendor command information.

The ‘Give Surround Speaker Status’ information can indicate information for requesting audio device connection status information from the display device 100 to the audio device 300. When the audio device 300 receives the Give Surround Speaker Status information, it can generate connection status information between the main audio device and the auxiliary audio device. At this time, if necessary, the main audio device can transmit and receive a signal for connection status confirmation to the auxiliary audio device.

The value (VedorOpcode) of the ‘Give Surround Speaker Status’ information can be assigned the value ‘0x5c’ , but is not limited thereto. Meanwhile, the ‘Give Surround Speaker Status’ information can be transmitted to the audio device selected from the display device 100, for example, when the audio device is selected from the home hub in the display device 100.

The ‘Report Surround Speaker Status’ information can indicate information used when returning audio connection information of the audio device 300, corresponding to the aforementioned ‘Give Surround Speaker Status’ information. As described above, when the ‘Give Surround Speaker Status’ information is received from the display device 100 or an update signal of the auxiliary audio device is received regardless, the audio device 300 can generate audio connection status information and transmit it to the display device 100 through the ‘Report Surround Speaker Status’ information. However, when the ‘Give Surround Speaker Status’ information is received from the display device 100, the audio device 300 can transmit a confirmation signal to confirm the connection status information at that point in time with the auxiliary audio device as needed, and can confirm or update the audio connection status information based on the result and return it to the display device 100.

The value (VedorOpcode) of the ‘Report Surround Speaker Status’ information can be assigned a value of ‘0x5d’ , but is not limited thereto.

Meanwhile, referring to FIG. 13, the vendor operand can be assigned 1 or 2 bytes to provide identification information on a speaker that can be connected as the first information.

Referring to FIG. 13, the vendor operand can provide speaker connection status information as the second information.

For example, the first information can include identifier information for woofer (0x01), rear L (0x02), rear R (0x04), rear Top (0x08), and rear side (0x10). This first information can be used as a bit mask.

The second information can be defined and used in the same manner as the first information, but can include information on the connection status. However, it is not limited thereto.

Next, an operation for processing status information of a (wireless) connection device for an audio device 300 as one of the audio device information is described as follows.

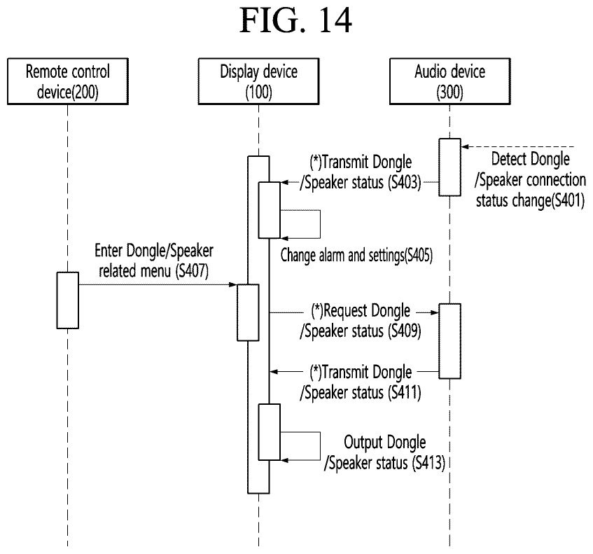

FIG. 14 is a flowchart illustrating an example of an operation method between a remote control device 200, a display device 100, and an audio device 300 in relation to providing connection status information of a wireless connection device for an audio device 300 in a display device 100 according to an embodiment of the present disclosure.

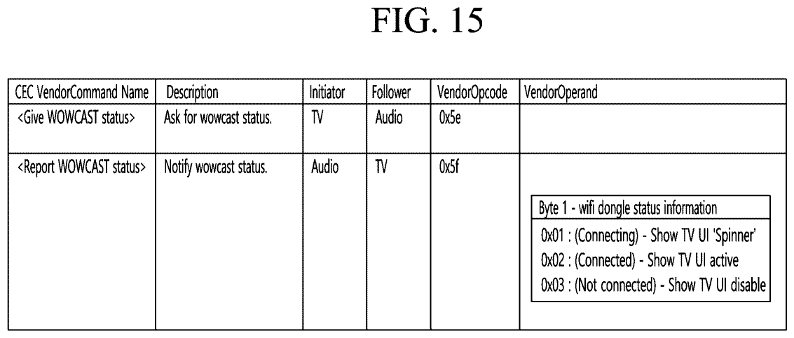

FIG. 15 is a diagram illustrating an example of a definition of a control command in relation to FIG. 14.

FIG. 14 is a diagram illustrating a processing operation of status information for a wireless connection device for an audio device 300, for example, wowcast.

For example, wowcast can refer to a device that enables an audio device 300 to be wirelessly connected to a display device 100 in a situation where it is difficult to connect a cable between the display device 100 and the audio device 300. This wowcast can be mounted on the rear of the display device 100 to enable HDMI eARC (enhanced ARC) connection between the display device 100 and the audio device (especially, the main body).

The wowcast can be attached/detached to the display device 100 in the form of a dongle, and can be mounted on any one of the external input ports provided in the display device 100. The wowcast can function not only between the display device 100 and the main audio device constituting the audio device, but also for the main audio device and the auxiliary audio device.

For convenience of explanation, FIG. 14 illustrates the latter, that is, the wowcast dongle (or HDMI dongle) functioning between the main audio device and the auxiliary audio device, but is not limited thereto.

In FIG. 14, the audio device 300 can represent the main body and, in particular, can collect information on the wireless connection status between the wowcast dongle and at least one component constituting the audio device through the wowcast dongle.

Referring to FIG. 14, the display device 100 can output connection status information between the audio device 300 and the wowcast dongle on the screen and provide it to the user.

The audio device 300 can receive wireless connection status information between the dongle/auxiliary audio device or detect a status change (S401).

When the audio device 300 receives the wireless connection status information of step S401 or detects a status change, it can transmit the wireless connection status information between the dongle/audio device (including the auxiliary audio device) to the display device 100 (S403).

In step S403, if the display device 100 receives wireless connection status information between the dongle/audio device from the audio device 300, it can output a notification message through the screen and change the settings based on the wireless connection status information (S405).

The display device 100 provides a user interface, and if an operation signal for the user to enter a menu related to wireless connection control between the dongle/audio device is received through the remote control device 20, it can request wireless connection status information between the dongle/audio device to the audio device 300 (S409).

The audio device 300 can identify wireless connection status information between the dongle/audio device of the display device 100 in step S409 and return it to the display device 100 (S411).

Data communication related to wireless connection status information between the display device 100 and the audio device 300 of FIG. 14 can utilize the HDMI-CEC protocol of FIG. 15 and can utilize vendor command information of the HDMI-CEC protocol. However, it is not limited thereto.

Referring to FIG. 15, the device 100, 300 uses ‘Give WOWCAST Status’ information and ‘Report WOWCAST Status’ information in the vendor command information as an example.

‘Give WOWCAST Status’ information can represent information for inquiring about the status of the wireless connection device, i.e., wowcast. ‘Give WOWCAST Status’ information can be used when requesting wireless connection status information of the audio device from the display device 100 to the audio device 300.

‘Give WOWCAST Status’ information can be generated from the display device 100 in FIG. 14 and transmitted to the audio device 300. At this time, the value (VedorOpcode) of the ‘Give WOWCAST Status’ information can be assigned a value of ‘0x5e’ , but is not limited thereto.

‘Report WOWCAST Status’ information can represent information that collects and returns status information of wowcast from the audio device 300, corresponding to the aforementioned ‘Give WOWCAST Status’ information.

‘Report WOWCAST Status’ information can be generated from the audio device 300 in FIG. 14 and transmitted to the display device 100. At this time, the value (VedorOpcode) of the ‘Report WOWCAST Status’ information can be assigned a value of ‘0x5f’ , but is not limited thereto.

Meanwhile, referring to FIG. 15, the vendor operand of the ‘Report WOWCAST Status’ information can be assigned 1 byte to define the status information of the wireless dongle. For example, if the status information value of the wireless dongle is ‘0x01’ , it indicates that the wireless connection (connection attempt) is in progress and is displayed as ‘Spinner’ on the user interface (or menu) of the display device 100, if the status information value is ‘0x02’ , it indicates that it is connected and is displayed as ‘Active’ on the user interface (or menu) of the display device, and if the status information value is ‘0x03’ , it indicates that it is not connected and is displayed as ‘disable’ on the user interface (or menu) of the display device 100. Meanwhile, the default value of the wireless dongle status information can be ‘0x02’ , but is not limited thereto.

The operation related to processing of equalizer (or audio effect) information of the audio device 300 as one of the audio device information is described as follows.

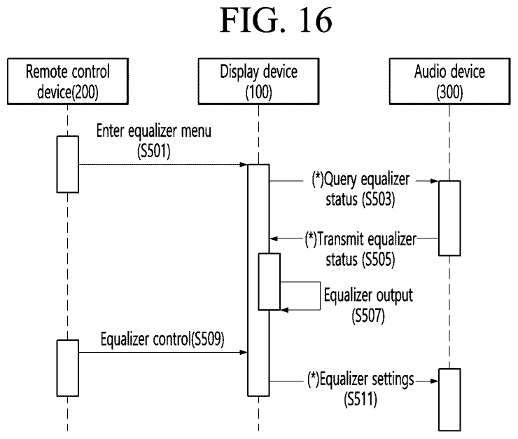

FIG. 16 is a flow chart illustrating an example of an operation method between a remote control device 200, a display device 100, and an audio device 300 in relation to providing equalizer information of an audio device 300 in a display device 100 according to an embodiment of the present disclosure. At this time, the audio device 300 can mean including at least one auxiliary audio device. That is, the display device 100 can obtain equalizer information of at least one auxiliary audio device and perform operations such as change settings.

FIG. 16 is a diagram illustrating an operation of processing equalizer information of an audio device 300.

The remote control device 200 can enter an equalizer menu (S501).

When a user operation signal for requesting equalizer information (or equalizer status information) of an audio device 300 connected through a remote control device 200 is received at step S501, the display device 100 can request (or inquire) equalizer information from the audio device 300 (S503).

When an equalizer information request is received from the display device 100 at step S503, the audio device 300 can collect equalizer information and return (i.e., transmit) it to the display device 100 (S505).

The display device 100 can output equalizer information of the audio device 300 on the screen based on the equalizer information collected and transmitted from the audio device 300 through step S505 (S507).

The remote control device 200 can access the equalizer information of the audio device 300 output on the screen of the display device 100 through step S507, and request equalizer control (S509).

The display device 100 can identify an equalizer control request received through the remote control device 200, generate an equalizer control command corresponding to the identified equalizer control request, and transmit it to the audio device 300 (S511).

The audio device 300 can parse the equalizer control command transmitted from the display device 100 in step S511, perform an operation according to the requested equalizer control, and return feedback.

Although not shown, data communication can be performed between the display device 100 and the audio device 300 for equalizer information exchange, control, etc., and as described above, vendor command information of the HDMI-CEC protocol can be used.

For example, the display device 100 can generate ‘Give EQ Status’ information and transmit it to the audio device 300 in order to inquire about the equalizer status of the audio device 300. When the audio device 300 receives the ‘Give EQ Status’ information, it can collect the equalizer status information and generate ‘Report EQ Status’ information and return it.

Meanwhile, when a request for equalizer control (change, etc.) is received through the remote control device 200, the display device 100 can generate ‘Set EQ Status’ information and transmit it to the audio device 300 in order to control the equalizer status of the audio device 300. When the audio device 300 receives ‘Set EQ Status’ information from the display device 100, it can parse the ‘Set EQ Status’ information, control it to have a corresponding equalizer state, and return feedback. The display device 100 can output and provide the equalizer state information of the controlled (changed) audio device 300 to the user by configuring and providing a necessary user interface according to the feedback of the audio device 100.

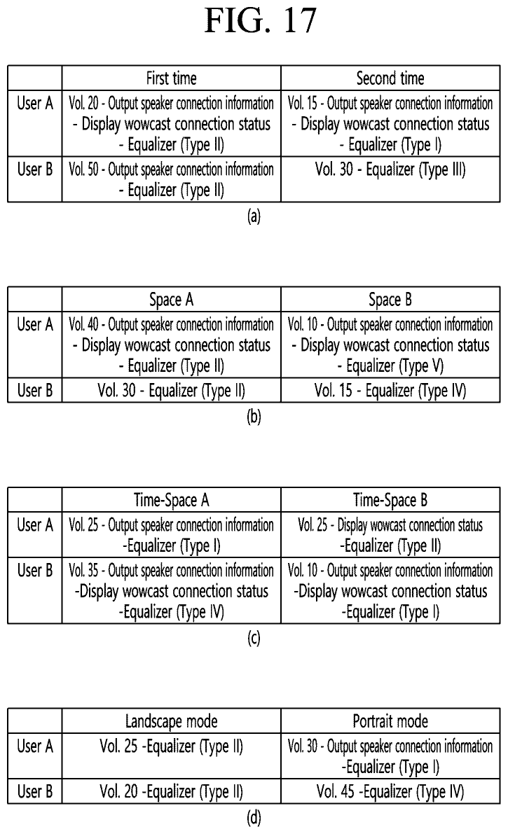

FIG. 17 is a drawing illustrating an operation related to providing information to the audio device 300 according to conditions in the display device 100 according to one embodiment of the present disclosure.

FIG. 17 can be a table that configures, for example, the operations to be performed between the remote control device 200 and the audio device 300 in the display device 100 mentioned in FIGS. 6 to 16 based on time (see FIG. 17(a)), space (see FIG. 17(b)), time-space (see FIG. 17(c)) information, based on the user, in a customized manner.

Each of the contents disclosed in FIG. 17(a) to 17(c) can be provided to control the audio device 300 even without user input through the remote control device 200 in the display device 100 if the corresponding condition is satisfied. In this process, data communication can be performed between the display device 100 and the audio device 300, as described above, and the HDMI-CEC protocol described in FIGS. 10, 13, 15, etc. can be used.

In the above, the individual information constituting the audio device information, that is, the volume level information in FIGS. 8 to 10, the connection status information in FIGS. 11 to 13, the wireless connection status information in FIGS. 14 and 15, and the equalizer information in FIG. 16, are individually described as functioning as audio device information. However, the present disclosure is not limited thereto, and the operations according to the information disclosed in the above-described FIGS. 8 to 16 can be appropriately combined with each other.

Even if not specifically mentioned, the order of at least some of the operations disclosed in the present disclosure can be performed simultaneously or in a different order from the previously described order, or some can be omitted/added.

According to one embodiment of the present invention, the above-described method can be implemented as a code that can be read by a processor on a medium in which a program is recorded. Examples of the medium that can be read by a processor include a ROM, a RAM, a CD-ROM, a magnetic tape, a floppy disk, an optical data storage device, etc.

The display device described above is not limited to the configuration and method of the embodiments described above, and the embodiments can be configured by selectively combining all or part of each embodiment so that various modifications can be made.

### INDUSTRIAL APPLICABILITY

According to the display device according to the present disclosure, the convenience of the user's use and control of the external device can be increased by configuring and providing a user interface regarding status information and control information for a connectable or connectable external device, so there is industrial applicability.

What is claimed is:

1. A display device comprising:
a display; and
a processor configured to control the display,
wherein the processor is configured to configure and output an external audio device information menu, when a first user input for the external audio device information menu is received, receive audio device information collected from an external audio device according to the first user input, and configure and output a user interface including at least one of current status information of the external audio device and control information for the external audio device based on the audio device information.

2. The display device of claim 1, wherein the audio device information includes at least one of information on a volume of the external audio device, connection status information of the external audio device, status information of a device for wireless connection of the external audio device, and equalizer information of the external audio device, and wherein the processor is configured to generate the current status information and the control information for each external audio device based on the audio device information.

3. The display device of claim 2, wherein when the first user input is received, the processor is configured to transmit a request signal of the audio device information to the external audio device.

4. The display device of claim 3, wherein the processor is configured to receive a second user input for control information in the user interface, generate an external audio device control command corresponding to the second user input, and transmit the external audio device control command to the external audio device.

5. The display device of claim 4, wherein the external audio device is configured to include a main audio device and an auxiliary audio device.

6. The display device of claim 5, wherein the processor is configured to transmit at least one of the request signal of the audio device information and the external audio device control command to the main audio device using an HDMI-CEC protocol.

7. The display device of claim 6, wherein the processor is configured to use vendor command information in the HDMI-CEC protocol.

8. The display device of claim 7, wherein the processor is configured to receive, from the main audio device, volume level information set according to the second user input, and output the volume level information through the display.

9. The display device of claim 8, wherein the processor is configured to output the volume level information, received from the main audio device, to the display, and wherein the processor is configured to convert and output a volume level range and the set volume level information of the main audio device to be matched with a volume level range of the display device.

10. The display device of claim 7, wherein the processor is configured to receive, from the main audio device, connection status information between the main audio device and the auxiliary audio device requested according to the second user input, and output the connection status information through the display.

11. The display device of claim 7, wherein the processor is configured to receive dongle and wireless connection status information for wireless connection between the display device and the external audio device requested according to the second user input, and output the dongle and wireless connection status information for wireless connection between the display device and the external audio device on a main display.

12. The display device of claim 7, wherein the processor is configured to receive equalizer setting information for the external audio device requested according to the second user input, and output the equalizer setting information through the display on a main display.

13. The display device of claim 1, wherein the processor is configured to pre-store information on a status of a preferred external audio device based on at least one of visual information and spatial information to which the display device belongs on the basis of a user logged into the display device, when providing the user interface, obtain information on at least one of the current visual information, the user currently logged into the display device, and the spatial information to which the display device belongs, and provide recommended information when the pre-stored information on the status of the preferred external audio device and the current status information of the external audio device included in the provided user interface are different from each other.

14. A display system comprising:
a remote control device;
an audio device; and
a display device including the display, which is configured to provide information on the audio device,
wherein the display device includes a processor that configures and outputs an external audio device information menu, when a first user input for the external audio device information menu is received, receives audio device information collected from an external audio device according to the first user input, and configures and outputs a user interface including at least one of current status information of the external audio device and control information for the external audio device based on the audio device information.

15. A method of operating a display device, comprising:
configuring and outputting an external audio device information menu;
receiving a first user input for the external audio device information menu;
receiving audio device information collected from an external audio device according to the first user input; and
configuring and outputting a user interface including at least one of current status information of the external audio device and control information for the external audio device based on the audio device information.
